(19) United States
(12) Patent Application Publication
(10) Pub. No.: US 2006/0131078 A1
(43) Pub. Date: Jun. 22, 2006

(54) Mobile chemical preparation plant and method of managing a chemical inventory thereon

(75) Inventor: Neale Browne, Houston, TX (US)

Correspondence Address: CARTER J. WHITE LEGAL DEPARTMENT;M-I L.L.C., 5950 NORTH COURSE DRIVE, HOUSTON, TX, 77072, US

(73) Assignee: M-I LLC

(21) Appl. No.: 11/303,130

(22) Filed: Dec. 16, 2005

Related U.S. Application Data
(60) Provisional application No. 60/637,497, filed on Dec. 20, 2004.

(51) Int. Cl. E21B 7/08

(52) U.S. Cl. 175/74

(57) ABSTRACT

A mobile chemical preparation plant and method of managing a chemical inventory is claimed. The mobile chemical preparation plant includes a mobile work area outfitted with a chemical compound preparation unit, a remote processing unit, and a global positioning system. Inventory of one or more chemical agents is also located within the mobile work area. The remote processing unit interfaces, remotely, with a central processing unit to monitor and manage inventory in the mobile work area. The method for managing inventory for a mobile chemical mixing plant that includes loading an initial inventory of one or more chemical agents into the mobile work area, recording the initial inventory, transporting the initial inventory and mobile work area to a remote location, preparing a chemical compound, recording the used inventory, calculating the remaining inventory, determining when a minimum inventory of one or more of the chemical agents remains in the mobile work area, locating the mobile chemical preparation plant, and replenishing the inventory.

This application claims priority to U.S. Provisional Patent Application 60/637,497 filed on Dec. 20, 2004 and entitled, “Mobile Chemical Preparation Plant and Method of Managing a Chemical Inventory Thereon” incorporated herein by reference.

### BACKGROUND OF INVENTION

When drilling or completing wells in earth formations, typically various fluids are used in the well for a variety of reasons. These fluids are often prepared at the drilling site by mixing ground, powdery material with a liquid. The drilling fluid material, generally packaged in bags or drums, is delivered to the drilling location via a van or truck.

The delivery vans or trucks may be owned by one of the drilling fluid materials suppliers or rented from an independent trucking company. The vans or trucks are filled with drilling fluid chemicals from one or more suppliers. Typically, many of the trucks transporting the drilling fluid chemicals have inadequate illumination in the storage area of the van and a poor stair system, making ingress and, particularly, egress with packaged drilling fluid material difficult.

Preparation of the drilling fluid generally takes place in a mixer at a location outside of the delivery truck. The packaged drilling fluid material must be removed from the truck and taken to the mixer to prepare the fluid. It would be an improvement to prepare the drilling fluid onboard the delivery truck and incorporate the equipment used to prepare the drilling fluid into the line providing drilling fluid to the rig. By bringing the delivery truck “in-line” with the preparation and drilling process, the extra steps and time associated with moving material to prepare the drilling fluid would be eliminated.

Otherwise commonplace features such as loading/unloading docks and lift trucks may not be present at many drilling locations. Thus, the van or truck remains at the drilling location and individuals must physically carry drilling fluid material from the truck to a mixer to prepare the drilling fluid.

It would be an improvement in the art to remove the need to hand carry packages of drilling fluid material from the delivery truck. By removing the need for an individual to carry inventory off of the truck, safety to the operator can be improved. In addition, inventory can be monitored more closely to ensure it is used for its intended purpose as well as to minimize the loss of material due to various causes located outside of the truck. Further, the potential hazard associated with contaminating the ground with spilled material is reduced when the material is not hand carried to another location from the truck.

The accuracy of inventory on the delivery truck is influenced by many factors. The trailer may be associated with the drilling of several shallow wells in succession without replenishment of inventory between wells. Further, at many drilling locations, inventory is managed by the drilling contractor, who works for the operator. As the operator is responsible for paying for consumed inventory, the drilling contractor is often not concerned with keeping accurate count of the inventory used. Thus, the inventory consumed at each drilling site may be difficult to ascertain and the drilling fluid material suppliers must rely on the drilling contractor to report the usage at each site.

The inventory consumed, in total by all well sites visited by a trailer, can be determined by calculating the difference between the initial inventory loaded onto the trailer and the remaining inventory on the trailer when it returns to the replenishment location, such as a warehouse or plant. However, it is not unusual for the calculated inventory consumption and the reports of inventory consumed from each of the drilling contractors at the rig locations to be irreconcilable.

It would be an improvement to the art to have a system to track the quantity of inventory consumed by each rig operator. By accurately tracking the inventory consumed at each drilling location, the costs to the drilling fluids suppliers associated with inventory loss can be minimized. Further, knowledge of the actual quantity of drilling fluid used at a particular location can aid engineers attempting to provide drilling fluid solutions to operators at that particular site.

Tracking the location of individual trailers is usually the responsibility of the drilling fluid company. When the same trailer is used to transport drilling fluid chemicals to several well locations, on occasion every two or three days, keeping track of the physical location of an individual trailer can be difficult. Further, trailers are regularly abandoned on location. It would be an improvement in the art to be able to keep track of individual trailers. By tracking the location of individual trucks, inventory can be efficiently provided to drilling locations.

Trailers that are depleted of inventory typically return to a local warehouse for restocking, with little or no maintenance being performed, including general cleaning. Bags are sometimes used to package the chemicals and leaving such bags empty and unattended outdoors presents potential environmental risks. The bags are often “disposed of” in the trailer, leaving the trailer dirty and requiring additional work to clean the trailer. It would be an improvement to provide a means for container disposal within the trailer so that empty containers are safely stowed during transport.

### SUMMARY

In one aspect, the claimed subject matter is generally directed to a mobile chemical preparation plant that includes a mobile work area outfitted with a remote processing unit and a chemical compound preparation unit. Inventory of one or more chemical agents is also located within the mobile work area. The remote processing unit interfaces, remotely, with a central processing unit to monitor and manage inventory in the mobile work area. The chemical compound preparation unit is housed within the mobile work area and may be any type of apparatus required to prepare the final product, such as a mixer, shaker, heater, or cooler. Valved inlets and outlets to the chemical compound preparation unit provide the ability to include the mobile chemical preparation unit serially within a larger process.

In one embodiment, the mobile work area may also include a chemical agent conveyor system to transfer each chemical agent from its storage container to the mixer without the need for physically lifting any of the bags of chemical agent or moving containers within the work area. The chemical agent conveyer system may also be used if another type of container is used to ship and store the chemical agent.

In another embodiment, a global positioning system (GPS) is incorporated into the mobile work area. The GPS transmits location data to a central processing unit so that the location of the mobile chemical preparation plant may be determined at any time or position data updated on a periodic basis.

In another embodiment, a trash compactor is incorporated into the mobile workspace. The trash compactor may be used to discard used bags or disposable containers. The trash compactor may further include an electronic reader to scan container information when the container is being discarded and input such information to the remote processing unit automatically.

In another embodiment, products related to the overall process may be included in an otherwise unused area of the mobile workspace, such as under the workspace floor. Such related products may include individual items or components of other equipment used in the overall process.

In another embodiment, test equipment is provided to ensure proper preparation of the chemical compound. The form of such test equipment is dependent upon the properties of the chemical compound being prepared in the work area.

In another embodiment, interactive support related to the chemical compounds being prepared is available through the remote processing unit. Such interactive support may come from software applications loaded onto the remote processor or from online communications with support personnel.

In a second aspect of the invention, the claimed subject matter is directed to a method for managing inventory for a mobile chemical mixing plant that includes loading an initial inventory of one or more chemical agents into the mobile work area, recording the initial inventory, transporting the initial inventory and mobile work area to a remote location, preparing a chemical compound, recording the used inventory, calculating the remaining inventory, determining when a minimum inventory of one or more of the chemical agents remains in the mobile work area, locating the mobile chemical preparation plant, and replenishing the inventory.

In one embodiment, the initial quantities are recorded on the remote processing unit, which also determines when the minimum inventory remains as chemical compounds are prepared. The remote processor transmits such data to a central processing unit, which determines the best method for replenishment of the inventory. The central processing unit then transmits replenishment information to the remote processing unit, which is communicated to the operator.

In another embodiment, the initial quantities are recorded on the remote processing unit and the central processing unit. The quantity of inventory consumed is input into the remote processing unit, which transmits the data to the central processing unit. The central processing unit, taking into account other factors, determines when a minimum inventory remains. The central processing unit transmits replenishment information to the remote processing unit, which data is then communicated to the operator.

In another embodiment, the initial inventory is recorded on the central processing unit. The quantity of inventory consumed is input into the remote processing unit, which transmits such data to the central processing unit. The central processing unit then determines the remaining quantity and whether the minimum inventory remains. If the minimum inventory remains, the central processing unit determines how the inventory will be replenished and transmits such information to the remote processing unit. The remote processing unit then supplies such information to the operator.

A system for preparing chemical compositions and monitoring chemical inventory in mobile work areas is also claimed. The system further includes a remote processing unit within each mobile work area having an inventory control software application and communicating remotely with a central processing unit. A mixing station is provided in each mobile work area for preparing a chemical compound from at least one chemical agent, the quantities of which are recorded on the remote processing unit and transmitted to the central processing unit when, or soon after, they are used. The inventory status is calculated for each chemical agent in the mobile work area and is communicated to the central processing unit, wherein the minimum acceptable quantity of one or more chemical agents remaining within the mobile work area is identified. A global positioning system affixed to the mobile work area provides location data to the central processing unit, which can determine the location of the mobile work area.

In one embodiment of the system, the inventory of a mobile chemical preparation plant may be replenished at the remote location by inventory from a stocked vehicle. In another embodiment of the system, the mobile chemical preparation plant having low inventory quantities may be replaced by another, stocked, mobile chemical preparation plant. In each of these embodiments the chemical compound may be prepared with minimal disruption or down-time.

Other aspects and advantages of the claimed subject matter will be apparent from the following description and the appended claims.

### BRIEF DESCRIPTION OF THE DRAWINGS

FIG. 1 is a top view of an embodiment of a mobile chemical preparation plant.

FIG. 2 is a cutaway view of a second embodiment of a mobile chemical preparation plant.

FIG. 3 is a side view of the mobile chemical preparation plant serially located within an overall process.

FIG. 4 is a diagram of the remote processing unit.

FIG. 5 is a side view of a pallet of bags of chemical agent.

FIG. 6 is a top view of an embodiment of a mobile chemical preparation plant with a chemical agent conveyor system, global positioning system, trash receptacle.

FIG. 7 is a side view of an embodiment of a component of a chemical conveyor system.

FIG. 8 is a front cutaway view of a trash collector.

FIG. 9 is a partial cutaway view of an embodiment of the mobile chemical preparation plant with a trash collector and a collection area.

FIG. 10 is a cutaway view of an embodiment of a mobile chemical preparation plant.

FIG. 11 is a flow chart of an embodiment of a system for tracking inventory of a remote mobile chemical preparation plant.

FIG. 12 is a flow chart of the inventory cycle.

FIG. 13 is a diagram of a central location servicing a plurality of remote locations.

FIG. 14 is a diagram of a plurality of facilities servicing a plurality of remote locations.

### DETAILED DESCRIPTION

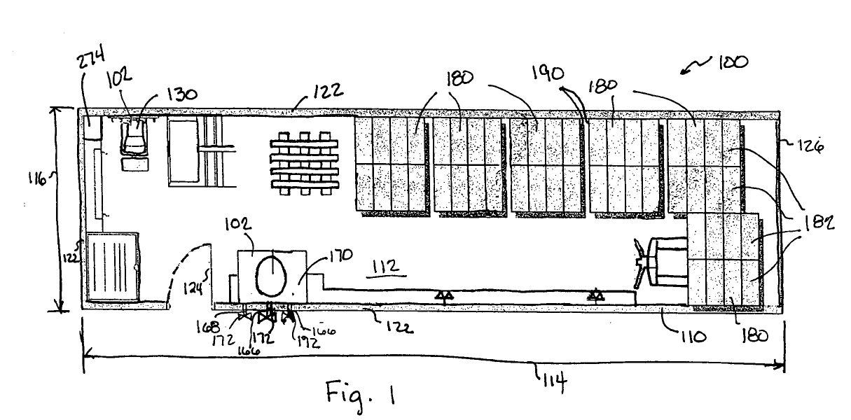

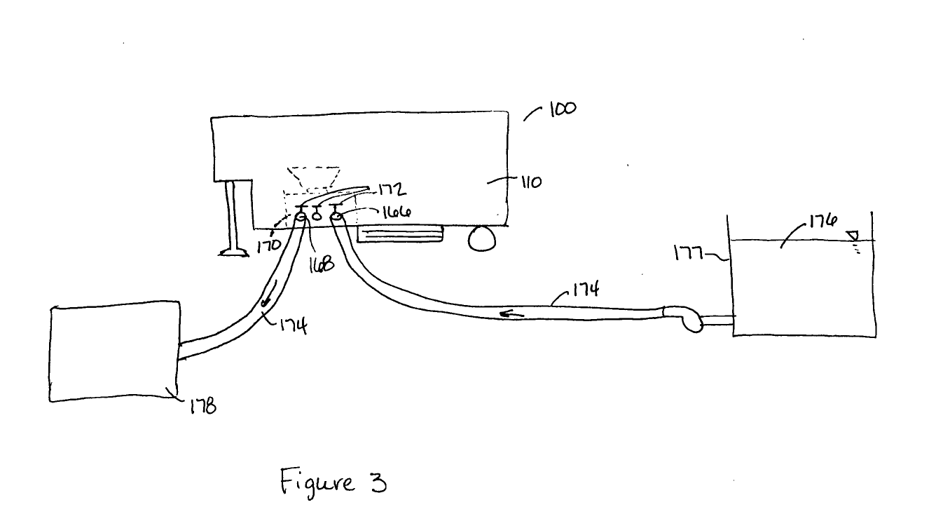

Referring to FIG. 1, an embodiment of a mobile chemical preparation plant 100 is depicted. The mobile chemical preparation plant 100 includes a mobile work area 110, a remote processing unit 130, a chemical composition preparation unit 170, and inventory of one or more chemical agents. As depicted in FIG. 3, the mobile chemical preparation plant 100 may be incorporated into an overall process, wherein the mobile chemical preparation plant 100 is used to perform one or more steps of a multi-step process.

Referring again to FIG. 1, the mobile work area 110 is a transportable space in which equipment 102, including the chemical composition preparation unit 170 and the remote processing unit 130, are housed along with an inventory of one or more chemical agents 182 required for the preparation of chemical compositions. The term “equipment” as used herein refers to any non-inventory machines or devices in the mobile work area 110. Examples of mobile work areas 110 include an enclosed semi trailer van, or even a bus having most or all of the seats removed. It is also contemplated that mobile work areas 110 may be on transportable flatbeds, leaving the workspace open rather than enclosed, although such an embodiment would likely have limited use as environmental conditions may not always be suitable.

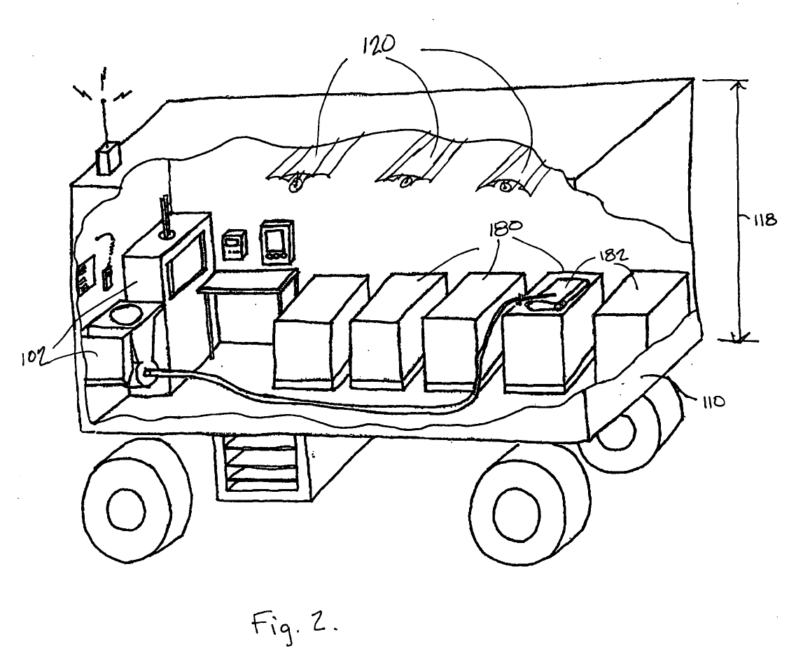

The work area floor 112 should have a floor length 114 and a floor width 116 sufficient to permit an operator (not shown) to access the inventory of chemical agent 182 and to use the equipment 102. Likewise, the work area 110 should have a station height 118 (shown in FIG. 2) defined by the height of outer walls 122 sufficient to permit the operator to move safely throughout the work area 110. A hinged door 124 may be provided for the ingress and egress of people into and out of the mobile work area 110. A sliding door 126 is provided for loading the inventory of one or more chemical agents 180 into the mobile work area 110 and unloading pallets or reusable shipping containers from the mobile work area 110.

Referring to FIG. 2, lighting 120 sufficient for the operator (not shown) that is using the mobile work area 110 to see clearly the inventory and equipment 102 should be provided. Climate control (not shown), such as a heater, fan, or small air conditioning unit may be included. While such climate control may be included as a convenience to the operator using the mobile work area 110, it may be necessary to provide a controlled environment for storage of certain chemical agents 182 or for preparing chemical compositions.

Turning back to FIG. 1, the chemical composition preparation unit 170 is located within the mobile work area 110. For purposes of preparing drilling fluid, the preparation unit 170 is a mixer. It is contemplated that one or more other types of preparation units 170, such as a heater, a cooler, a purifier, or any equipment 102 required to achieve the desired blending or reaction necessary for production of the chemical composition may be included for other purposes. For example, the chemical composition preparation unit 170 may be a shaker for the preparation of paint.

Placement of the preparation unit 170 may be anywhere within the work area 110, but is preferably located with such parameters in mind as the location of a power supply 274 (if needed), the ease and efficiency with which an operator may use the preparation unit 170 in the location, and the immediate and final disposition of the produced chemical composition. If additional chemical components are required to be pumped into the preparation unit 170, then access to the ports through which such components will be supplied must also be considered when locating the preparation unit 170 within the mobile work area 110.

As previously mentioned, the mobile chemical preparation plant 100 may be incorporated into an overall process as shown in FIG. 3. The preparation unit 170 may perform one or more sub-processes. In such a case, it may be necessary to have additional chemical components pumped into the preparation unit 170. One or more inlets 166 may be provided through the outer wall 122 of the mobile work area 110 through which additional chemical components may be directed. The preparation unit 170 is fluidly connected to each inlet 166. Each inlet 166 may further include a control valve 172 to control the flow into the preparation unit 170. An outlet 168 may be provided through the outer wall 122 through which the resulting chemical compound may be directed from the preparation unit 170 to another processing unit or collection tank 178. A control valve 172 may be provided on the outlet 168 to control the flow to the processing unit or collection tank 178. In the example depicted in FIG. 3, fluid 176 is pumped through a conduit 174 to the preparation unit 170 located within the preparation plant 100. The fluid 176 may have been subjected to one or more chemical, mechanical or electric process prior to entering the preparation unit 170. Chemical agents 182 stored in the mobile work area 110 may be combined with the fluid 176 and pumped to another processing station 178 outside of the preparation plant 100. Alternatively, the combined fluid 176 and chemical agent 182 may constitute a final product that is pumped to the location 178 where the final product is to be used.

An example of incorporating the mobile chemical preparation plant into an overall process is the preparation and/or reconditioning of drilling fluid. To prepare a drilling fluid, a brine solution is often mixed with a chemical agent 182, typically a polymer. In this example, the brine solution may be fed into the preparation unit 170, i.e. a mixer, through the conduit 174 from a brine source external to the mobile work area 110. After mixing the brine solution with the chemical agent 182, the drilling fluid may be pumped to a storage tank or the drilling rig, represented by 178. To recondition a drilling fluid, used drilling fluid 176 that has been treated to remove cuttings and other contaminants is mixed with additional chemical agent 182 to replenish that which may have been removed during the cleaning process. The treated used drilling fluid 176 may be pumped from a treatment process or storage tank, represented by 178, to the preparation unit 170, i.e. the mixer, within the mobile work area 110. After the treated drilling fluid 176 is mixed with additional chemical agent 182, the reconditioned drilling fluid may be pumped to a storage tank or drilling rig, represented by 178.

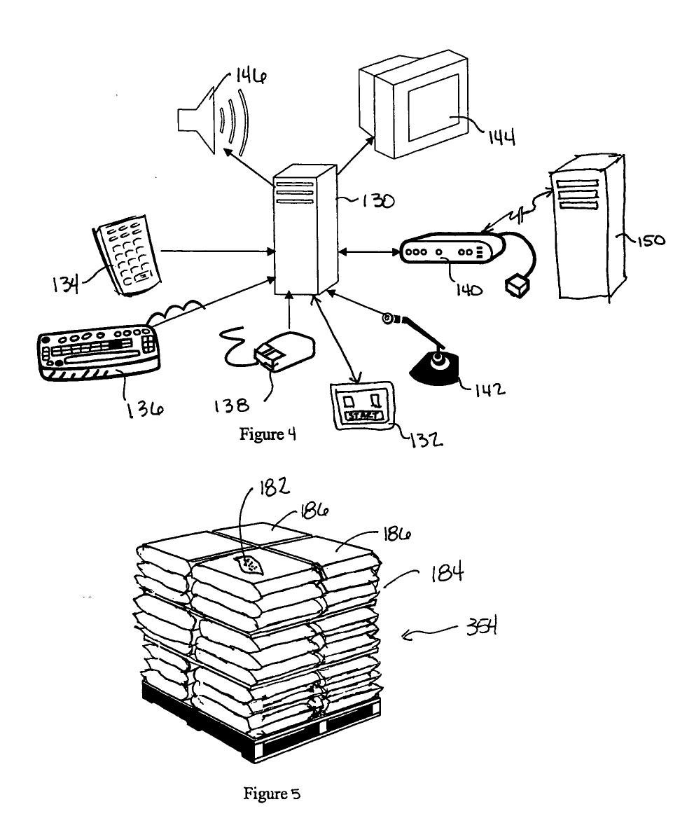

Referring to FIG. 4, a remote processing unit 130 is also located in the mobile work area 110. The remote processing unit 130 includes input and output capabilities as well as electronic memory. Although depicted in FIG. 4 as including peripheral equipment, the electronic memory, input devices, and output devices may be incorporated into a single device, i.e. without the use of additional peripheral equipment such as monitors, keyboards, etc.

Input to the remote processing unit 130 by an operator may be by a touch screen 132, a keypad 134, a keyboard 136, a mouse 138, and/or by remote communications via a modem 140. It is contemplated that data may also be input by voice command 142. Data may be input to the remote processing unit 130 automatically by incorporating into the process sensors and meters (not shown) that provide information about the process directly to the remote processing unit 130.

Output from the remote processing unit 130 is preferably by a visual screen readout 144. Additionally, audible alarms 146 or alerts may be incorporated to notify operators to the presence of certain conditions in the process, inventory levels, or environment, or even of incoming messages or data from another location. The modem 140 may also be included to communicate output to other remote processing units 130 and a central processing unit 150.

As will be discussed in further detail below, the electronic memory is sufficient to retain input data and store and execute software applications and algorithms necessary to maintain and track inventory.

Referring to FIGS. 1 and 5, an initial inventory 354 of chemical agents 182 is loaded into the mobile work area 110 in any suitable container 184. Examples of such containers 184 include reusable containers 188 and disposable containers 190. While dry chemical agents 182 are typically stored and transported in disposable containers 190 such as bags, it is contemplated that various types of containers 184 may be used, including bulk containers, boxes, canisters, barrels, or any other suitable type of containment. The containers 184 may be single use or reusable containers.

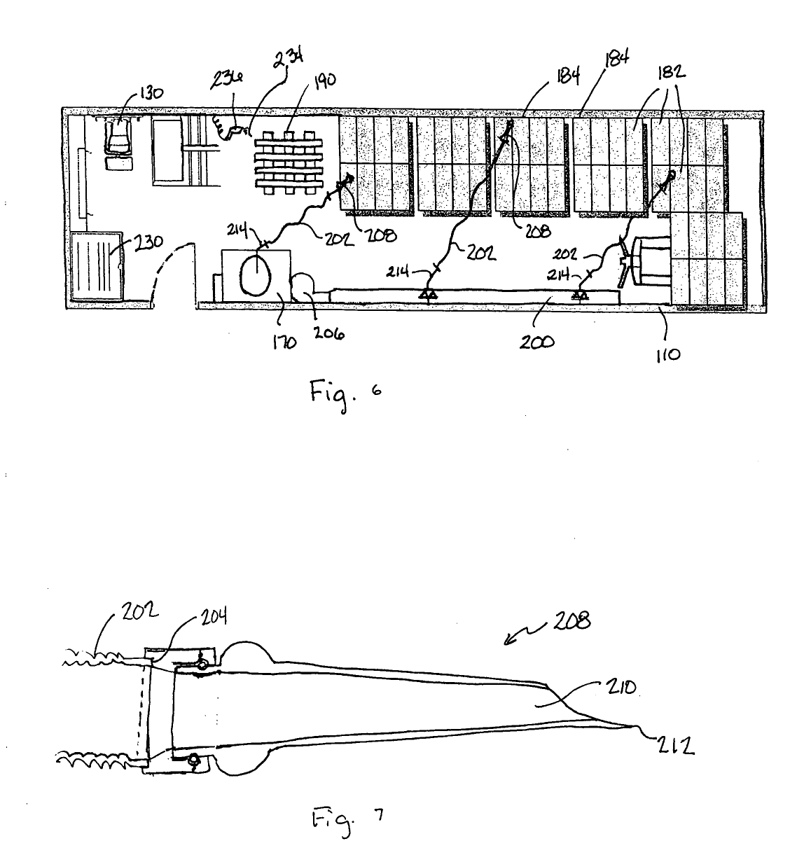

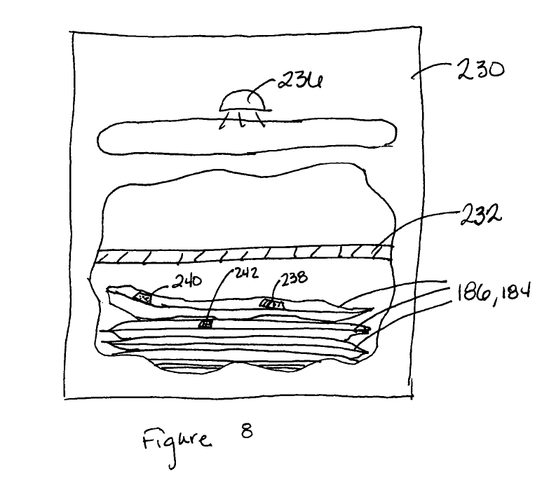

Referring to FIG. 6, a chemical agent conveyor system 200 may also be included within the mobile work area 110. The chemical agent conveyor system 200 may include one or more flexible hoses 202 connected to the chemical preparation unit 170. A pump 206 may be used to draw each chemical agent 182 from its respective storage container 184 to the chemical preparation unit 170. A sharp wand 208, depicted in FIG. 7, having an orifice 210 through its length may be attached to an end 204 of the flexible hose 202. The sharp end 212 of the wand 208 may be used to tear open containers 184 such as bags (shown in FIG. 5) storing the chemical agents 182.

To track inventory usage, a metering device 214 may be included in the chemical agent conveyance system 200. As chemical agent 182 is carried through the conveyance system 200, the quantity carried is metered. The meter 214 may be read manually to determine the quantity of chemical agent 182 used or the meter 214 may communicate such data to the remote processing unit 130.

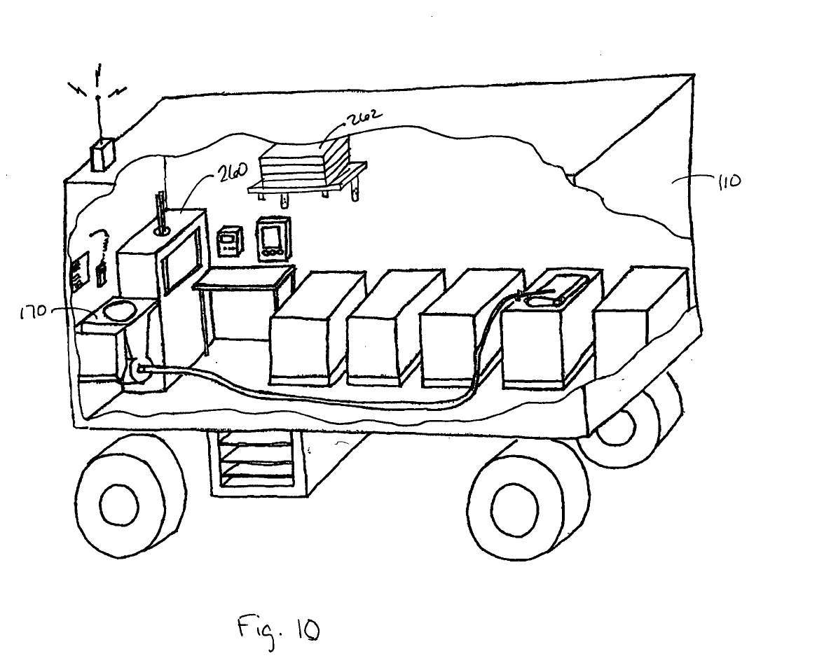

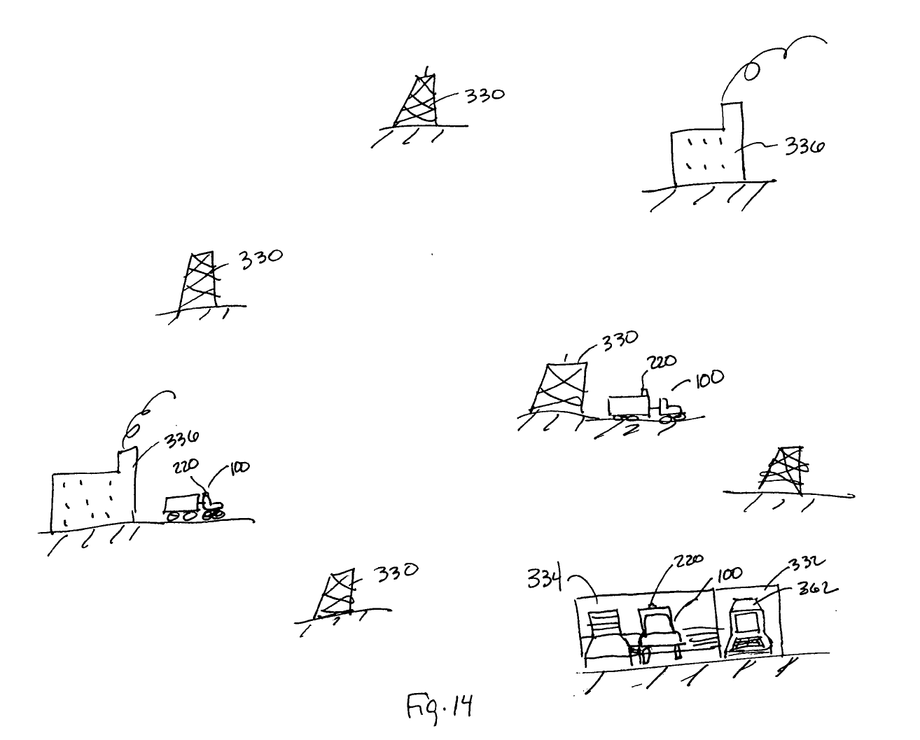

Referring to FIG. 9, a global positioning system 220 may be used to locate the mobile work area 110. A global positioning receiver 222 may be located on the mobile work area 110 such that position data is acquired from a plurality of satellites 224. The data captured by the global positioning receiver 222 may be transmitted to the remote processing unit 130. Periodically or upon request, the position data can be transmitted to a central processing unit 150 (depicted in FIGS. 13 and 14). Such data may be used to locate the mobile work area 110 at any given time. In addition, such data may be collected by the remote processing unit 130 as the used quantity of inventory is recorded, thereby providing location data at which individual quantities of chemical agent 182 were consumed.

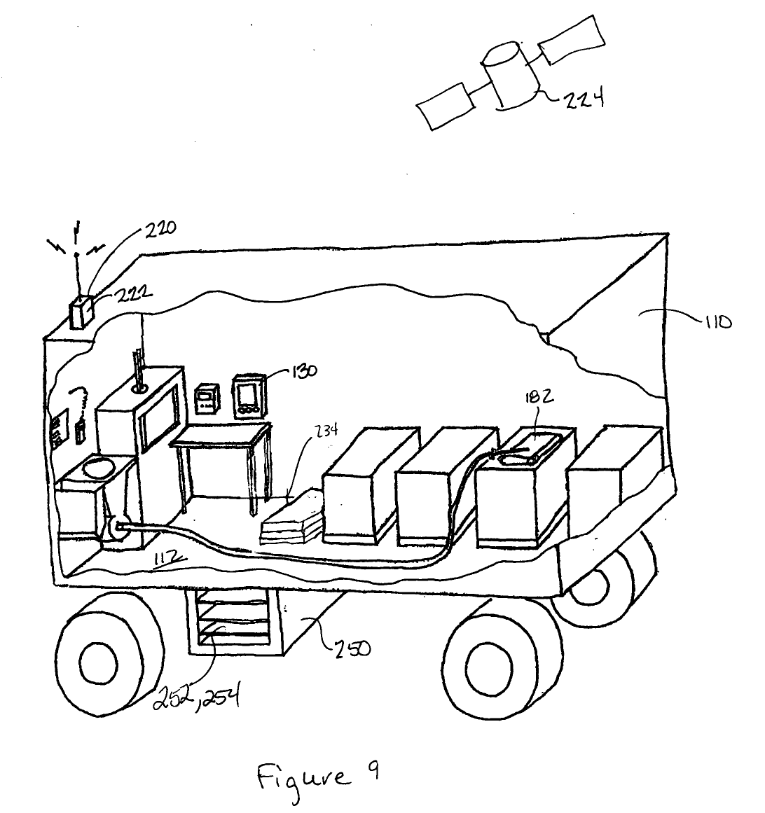

Referring to FIGS. 6 and 8, when disposable containers 190, such as bags, are used to store chemical agents 182 prior to their use, a trash collector 230 may be included in the mobile work area 110 to dispose of the used containers 190. A compactor 232 may be included in the trash collector 230 to minimize the volume of the used containers 184. Upon emptying the trash collector 230, the used containers 190 may be counted to ensure accurate chemical usage data.

Alternatively, or in addition to, the disposable containers 190, reusable containers 188 may be used. Reusable containers 188 may be used to house a known quantity of smaller disposable containers 190 or house the chemical agent 182 directly. A collection area 234 for reusable containers 188 may also be included in the mobile work area 110. The reusable containers 188 may be collected for reuse when the inventory is replenished or the mobile work area 110 is brought to a location for routine or special maintenance or storage.

Referring to FIG. 8, an automatic inventory tracking device 236 may be included with the trash collector 230 or reusable container collection area 234. The automatic inventory tracking device 236 may read a barcode label 238 on the disposable container 190 being discarded or the reusable container 188 being collected. Alternatively the device 236 may scan and recognize a Figure 240 on the face of the container 184. The reusable and/or disposable containers 188 or 190 may, alternatively, contain an electronic chip 242 that is automatically scanned by the automatic inventory tracking device 236 when the container 184 is placed in the trash collector 230 or reusable container collection area 234. The data collected by the automatic inventory tracking device 236 may be automatically communicated to the remote processing unit 130.

A related products storage area 250, shown in FIG. 9, may be included in the mobile work area 110 to provide or vend related products 252 to the activities at the remote worksite 330 (shown in FIGS. 13 and 14) and/or the chemical compounds being produced. In the embodiment shown in FIG. 9, shale shaker screens 254, often used at drilling sites to remove impurities such as cuttings from drilling fluid, are stored beneath the work area floor 112.

For other types of mobile chemical preparation plants 100, used to prepare chemical products other than drilling fluids, other types of related products 252 may be available in the related products storage area 250. Examples of such related products 252 may be paint brushes for a mobile chemical preparation plant 100 outfitted to prepare paint or cleaning rags or tools for a preparation plant 100 that is used to prepare cleaning solutions.

Referring to FIG. 10, test apparatus 260 or kits 262 to test the chemical agents 182 and/or the resulting chemical compound may be included in the mobile work area 110. Additionally, sensors (not shown) may be included in the chemical preparation unit 170 to notify an operator when control limits or tolerances are exceeded as the chemical process or mixing occurs.

The remote processing unit 130 in the mobile work area 110 may be used to provide onsite technical support to operators in the mobile work area 110. Manuals related to the chemicals and processes being performed can be stored in the remote processor memory. Additionally, remote support from an online technician may be made available through the remote processing unit.

Power should be available within the mobile work area 110 to supply the remote processing unit 130, lighting 120, and the chemical composition preparation unit 170. If included, the chemical agent conveyor system 200, trash compactor 232, global positioning system 220, or test apparatus 260 may require power. Power may be provided by a generator 270, a remote hookup 272, or by the same vehicle power used to transport the mobile work area 110.

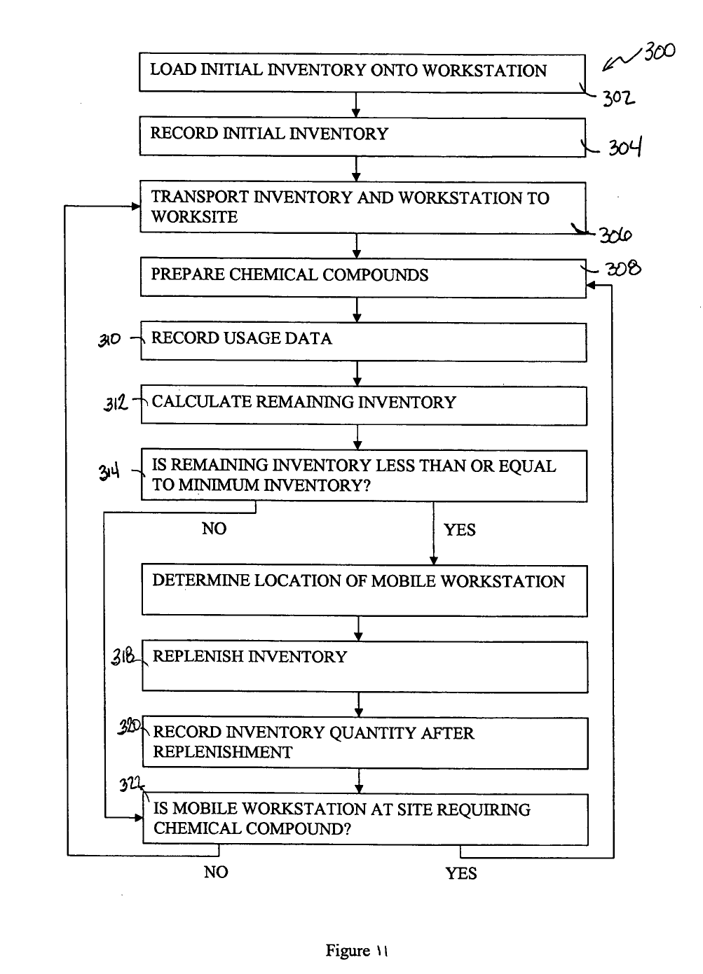

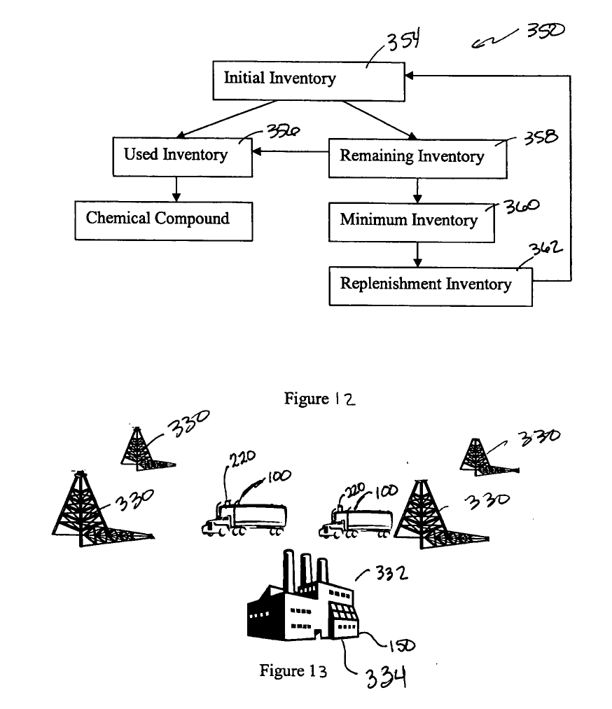

A method 300 for managing inventory of one or more chemical agents 182 is depicted in FIG. 11. Before turning to the method 300, however, it may be useful to understand the inventory cycle 350, depicted in FIG. 12, on the mobile chemical preparation plant 100.

Referring to FIG. 12, the inventory cycle 350 is depicted. Inventory in the mobile work area 110 generally may be categorized as initial inventory 354, used inventory 356, remaining inventory 358, minimum inventory 360, and replenishment inventory 362. The initial inventory 354 is the quantity of chemical agents 182 first loaded into the mobile work area 110. The used inventory 356 is the quantity of chemical agent 182 used in the production of the chemical compound. The remaining inventory 358 is the quantity of inventory left after the production of the chemical compound. The remaining inventory 358 may also be calculated by subtracting the used inventory 356 from the initial inventory 354. The minimum inventory 360 is a predetermined or precalculated quantity of chemical agent 182 representing the quantity that triggers replenishment. That is, if the quantity of chemical agent 182 reaches or falls below the minimum inventory 360, remaining inventory 358 should be replenished to avoid running out of a particular chemical agent 182. Replenishment inventory 362 is a quantity of chemical agent 182 added to the remaining inventory 358.

Referring to FIGS. 1 and 11, the inventory management method 300, includes a loading initial inventory process 302, an initial inventory recording process 304, a transporting process 306, a preparing chemical compound process 308, a recording usage data process 310, a calculating process 312, an inventory determination process 314, a work area location process 316, an inventory replenishment process 318, a recording replenishment inventory process 320, and a job location process 322.

In the loading initial inventory process 302, the mobile work area 110 is physically stocked with an initial quantity of one or more chemical agents 182. Each chemical agent 182 will be held in one or more storage containers 184. When loading the initial inventory into the mobile work area 110, the initial inventory may be packaged in any of a variety of ways, including a bulk storage container such as a barrel, a pallet of bags 186, boxes, plastic containers, disposable or reusable.

In the initial inventory recording process 304, the quantity of storage containers 184 loaded into the mobile work area 110 is input into the memory of the central processing unit 150. The central processing unit 150 includes an inventory management software application capable of receiving inventory data from one or more remote processing units 130 and calculating when minimum inventory 360 is reached. The inventory management software application can also calculate when replenishment inventory 362 is required at any remote location in which there is a remote processing unit 130.

Alternatively, or in addition to, the initial inventory quantities may be input into the remote processing unit 130. The remote processing unit 130 includes an inventory control software application capable of receiving direct input inventory data and configuring the inventory data for transmittal to the central processing unit 150.

Referring to FIGS. 1 and 13, in the transporting process 306, the mobile chemical preparation plant 100, containing the initial inventory 354 is moved to a remote worksite 330. The mobile chemical preparation plant 100 may move from a central facility 332, such as a factory or warehouse, to a remote worksite 330 or may move between remote work sites 330. As shown in FIG. 3, the mobile chemical preparation plant 100 may be connected to other processing equipment or tanks 177, 178 through one or more inlets 166 and an outlet 168 so that it is part of a larger, overall process.

Referring again to FIGS. 1 and 11, in the preparing chemical compounds process 308, some or all of the initial inventory of chemical agent 182 is used to prepare the chemical product. The quantity of used inventory 356 of chemical agent 182 depends upon the amount used to prepare the chemical product, the amount of product produced, and the amount of chemical agent 182 that is lost due to various process losses.

In the recording usage data process 310, the quantity of used inventory is recorded. The usage data may be input into the remote processing unit 130 manually based on a physical count of units, containers, or bags 186 of chemical agent 182 used. If any type of automatic inventory tracking device 236 or metering device 214 is used, the data collected by the device 236 or 214 may be input to the remote processing unit 130. Such data may be input manually or automatically communicated by the device 236 or 214 to the inventory control software application on the remote processing unit 130.

In the calculating process 312, the quantity of inventory remaining on the mobile chemical preparation plant 100 is determined. The calculation may be performed by the inventory management software application on the central processing unit 150 or by the inventory control software application on the remote processing unit 130. If the calculation is to be performed by the inventory management software application, then the recorded usage data must be transmitted to the central processing unit 150. The inventory control software application on the remote processing unit 130 may also calculate the remaining inventory 358. The resulting quantity may be communicated to the inventory management software application on the central processing unit 150 or may be used to check a physical inventory count on the mobile chemical preparation plant 100.

Referring to FIGS. 7, 9, and 11, the quantity of each chemical agent 182, or raw material, used is recorded in at least one of several ways. First, the quantity of chemical agent 182 used may be recorded manually by inputting the data to the remote processing unit 130 as the chemical agent 182 is used or by counting empty containers 184 and inputting such data. Second, when a conveyance system 200 is used to move the chemical agent 182 from the storage container 184 to the chemical composition preparation unit 170, the usage of chemical agent 182 may be metered. Third, an automatic inventory tracking device 236 may be used to scan a chip 242 or label 238 upon emptying a storage container or upon discarding a storage container.

Returning to FIGS. 1 and 11, in the inventory determination process 314, the remaining inventory 358 quantity is compared to the minimum inventory 360 to determine whether the remaining inventory 358 must be replenished. The determination of whether replenishment inventory 362 is required depends upon the minimum inventory 360 quantity. The minimum inventory 360 may be based on many factors, including historical usage data associated with other remote locations, forecasts, and the locations of other mobile work areas. Thus, the minimum inventory of a first chemical agent 182 on a first mobile chemical preparation plant 100 may be different from the minimum inventory 360 on a second mobile chemical preparation plant 100, leading to differing decisions regarding replenishment for the first mobile chemical preparation plant 100 and the second mobile chemical preparation plant 100 although they have identical remaining inventories 358 of the first chemical agent 182.

Once the inventory management software application has determined whether the remaining inventory 358 is less than, equal to, or greater than the minimum inventory 360, the inventory control software application is capable of receiving remote instruction from the central processing unit 150 regarding the way in which replenishment inventory 362 will be provided, if at all.

Referring to FIGS. 11, 13 and 14, in the work area location process 316, the location of the mobile chemical preparation plant 100 is determined. Each mobile chemical preparation plant 100 may be equipped with a global positioning system 220 that may communicate location data to the remote processing unit 130. The remote processing unit 130 may then transmit the location data to the central processing unit 150. Alternatively, the global positioning system 220 may communicate location data directly to the central processing unit 150.

If the mobile chemical preparation plant 100 does not have a global positioning system 220, then the work area location may be communicated by an individual at the work area to another individual at a central facility 332 or to the central processing unit 150 directly, for example telephonically (not shown).

In the inventory replenishment process 318, replenishment instructions are be communicated to the individual or individuals at the mobile chemical preparation plant 100 and the inventory may be replenished.

The replenishment instructions may be determined based upon one or more factors, including the location of the mobile chemical preparation plant 100, the location of one or more warehouses 334, the location of one or more chemical agent production facilities 336, the remaining chemical compound needs at the present worksite 330 of the mobile chemical preparation plant 100, and the chemical compound needs and locations of other sites to which the mobile chemical preparation plant 100 may be dispatched.

Depending upon the factors considered, the mobile chemical preparation plant 100 may be replenished at its current worksite 330 by a runner vehicle 340. Alternatively, the mobile chemical preparation plant 100 in need of replenishment may be replaced by another mobile chemical preparation plant 100, in which case the mobile chemical preparation plant 100 to be replenished may return to a central facility 332, warehouse, plant, or even another worksite 330. Another alternative is that the mobile chemical preparation plant 100 is replenished at a warehouse or plant and returns to the original worksite 330. Based upon the usage data or remaining quantity data received by the central processing unit 150, the inventory management software application is used to determine whether replenishment inventory 362 is required by the mobile chemical preparation plant 100.

In the recording replenishment inventory process 320, the quantity of chemical agent 182 loaded onto the mobile chemical preparation plant 100 as replenishment inventory 362 is recorded. The replenishment inventory 362 may be recorded on the remote processing unit 130, the central processing unit 150, or both. Alternatively, the total quantity of chemical agent 182 on the mobile chemical preparation plant 100 after the addition of chemical agent replenishment inventory 362 may be recorded in the remote processing unit 130, the central processing unit 150, or both.

In the job location process 322, the location of the next chemical preparation job is determined and communicated to an individual at the mobile chemical preparation plant 100, preferably through the remote processing unit 130. The mobile chemical preparation plant 100 may or may not be required to move to a new work site 330.

If the mobile chemical preparation plant 100 is to remain at its current job worksite 330, then preparation of the chemical compounds may commence after replenishment inventory 362 is received and recorded. If the mobile chemical preparation plant 100 has to relocate for its next chemical preparation job, then the mobile chemical preparation plant 100 is transported to the new work site 330 to begin preparing the desired chemical compounds.

To replenish the inventory at the mobile chemical preparation plant 100, such inventory may be transported from a warehouse 334 or production facility 336 to the remote worksite 330 of the mobile chemical preparation plant 100 as confirmed by the central processing unit 150 in communication with the remote processing unit 130. Alternatively, a replacement mobile chemical preparation plant 100 having a fresh inventory may be exchanged for the original mobile chemical preparation plant 100 at the remote worksite 330. Alternatively, the mobile chemical preparation plant 100 may be returned to a central facility 332 and replenished before being dispatched back out to a remote worksite 330, either the same one it left or a new worksite 330.

Those of ordinary skill in the art will recognize that other embodiments other than those described above may be used without departing from the scope of the present invention. In particular, many inventory management algorithms may be used, without departing from the inventory management systems and methods disclosed in the present application. Therefore, no limitation on the scope of the claimed subject matter is intended by reference to specific methods.

Those of ordinary skill in the art will further recognize the many applications of the apparatus and method disclosed herein in addition to the preparation of drilling fluids at drilling sites. Such other applications may include the onsite preparation of paint, cleaning solutions, or other chemicals at the location where it is to be used. The use of the method to monitor and track mobile inventory may be applied to any industry in which individual vehicles containing inventory are dispatched to frequently changing job sites, such as construction or on-site vehicle repair.

While the claimed subject matter has been described with respect to a limited number of embodiments, those skilled in the art, having benefit of this disclosure, will appreciate that other embodiments can be devised which do not depart from the scope of the claimed subject matter as disclosed herein. Accordingly, the scope of the claimed subject matter should be limited only by the attached claims.

What is claimed is:

1. A method of managing inventory for a mobile chemical mixing plant comprising:
loading an initial inventory of at least one storage container of at least one chemical agent into a mobile work area;
recording the initial inventory of each chemical agent;
transporting the initial inventory and the mobile work area to at least one remote location;
preparing a chemical compound having a usage amount of at least one chemical agent, wherein the usage amount equals a used inventory amount;
recording the used inventory amount of each chemical agent used to prepare the chemical compound;
calculating a remaining inventory of each chemical agent in the mobile work area;
determining when the remaining inventory in the mobile work area is equal to or less than a minimum inventory of at least one chemical agent;
locating the mobile work area;
replenishing inventory of each chemical agent for which a minimum inventory or less was determined;
recording a final inventory in the mobile work area after replenishment inventory is added.

2. The method of claim 1, wherein the recording the initial inventory step comprises:
entering the initial inventory data on a central processing unit at a central location.

3. The method of claim 2, wherein the recording the initial inventory step further comprises:
entering the initial inventory data on a remote processing unit located within the mobile work area.

4. The method of claim 1 further comprising:
conveying a used inventory amount of at least one chemical agent from at least one storage container to a chemical compound preparation unit affixed within the mobile work area.

5. The method of claim 1, wherein the recording the used inventory amount step comprises:
entering the used inventory amount into a remote processing unit.

6. The method of claim 1, wherein the recording the used inventory amount step comprises:
transmitting the used inventory amount from a metering device to a remote processing unit.

7. The method of claim 1, further comprising:
communicating the used inventory amount of each chemical agent to an inventory management software application on a central processing unit;
wherein the remaining inventory is calculated with the inventory management software application
wherein determining when the remaining inventory in the mobile work area is equal to or less than the minimum inventory of at least one chemical agent is performed with the inventory management software application; and
communicating instruction for obtaining replenishment inventory to the mobile work area.

8. The method of claim 1, further comprising:
communicating the remaining inventory of each chemical agent in the mobile work area to an inventory management software application on a central processing unit;
wherein determining when the remaining inventory in the mobile work area is equal to or less than the minimum inventory of at least one chemical agent is performed with the inventory management software application; and
communicating instruction for obtaining replenishment inventory to the mobile work area.

9. The method of claim 1, wherein the replenishing inventory step comprises:
transporting the mobile work area to a central location to replenish the remaining inventory.

10. The method of claim 1, wherein the replenishing inventory step comprises:
replacing the mobile work area with a second mobile work area containing a second initial inventory.

11. The method of claim 1, wherein the replenishing inventory step comprises:
providing a replenishment inventory to the mobile work area at the remote location.

12. The method of claim 1, further comprising:
relocating the mobile work area to a different remote location.

13. A method for managing inventory at a plurality of mobile chemical mixing plants comprising:
loading an initial inventory of at least one chemical agent into each of a plurality of mobile work areas;
recording the initial inventory of each chemical agent loaded into each of the mobile work areas;
transporting each initial inventory and the corresponding mobile work areas to individual and remote locations;
preparing a chemical compound having a usage amount of at least one chemical agent in each of the mobile work areas;
wherein the usage amount equals a used inventory amount; and
wherein the used inventory amount is unique for each of the mobile work areas;
recording the used inventory amount of each chemical agent in each mobile work area;
calculating a remaining inventory for each chemical agent in each of the mobile work areas;
determining when the remaining inventory in each mobile work area is equal to or less than a minimum inventory of at least one chemical agent;
locating each mobile work area for which a minimum inventory or less was determined;
replenishing inventory of each chemical agent to each mobile work area for which a minimum inventory or less was determined;
recording a final inventory in each mobile work area after replenishment inventory is added.

14. The method of claim 13, wherein the recording the initial inventory step comprises:
entering the initial inventory data for each mobile work area on a central processing unit at a central location.

15. The method of claim 14, wherein the recording the initial inventory step further comprises:
entering the initial inventory data for each mobile work area on a remote processing unit correspondingly located within each of the mobile work areas.

16. The method of claim 13, wherein the recording the used inventory amount step comprises:
manually entering the used inventory amount for each mobile work area into a corresponding remote processing unit.

17. The method of claim 13, further comprising:
communicating the used inventory amount of each chemical agent from each remote processing unit to an inventory management software application on a central processing unit;
calculating when the remaining inventory in each mobile work area is equal to or less than the minimum inventory of at least one chemical agent; and
communicating instruction for obtaining replenishment inventory to each mobile work area for which minimum inventory or less was calculated.

18. The method of claim 13, wherein the recording the used inventory amount step comprises:
transmitting the used inventory amount from a metering device in each work area to a corresponding remote processing unit.

19. The method of claim 18, further comprising:
communicating the used inventory amount of each chemical agent from each remote processing unit to an inventory management software application on a central processing unit;
calculating when the remaining inventory in each mobile work area is equal to or less than the minimum inventory of at least one chemical agent; and
communicating instruction for obtaining replenishment inventory to each mobile work area for which minimum inventory or less was calculated.

20. The method of claim 13, wherein the replenishing inventory step comprises:
transporting each mobile work area for which minimum inventory or less was calculated to the central location to replenish the remaining inventory.

21. The method of claim 13, wherein the replenishing inventory step comprises:
replacing each mobile work area for which minimum inventory or less was calculated with another mobile work area containing a second initial inventory.

22. The method of claim 13, wherein the replenishing inventory step comprises:
providing replenishment inventory to each mobile work area for which the minimum inventory or less was calculated at the corresponding remote location.
